(19) United States
(12) Patent Application Publication
(10) Pub. No.: US 2006/0239212 A1
(43) Pub. Date: Oct. 26, 2006

(54) Management of missing conference invitees

(75) Inventors: Shamim S. Pirzada, Santa Clara City, CA (US); Cullen F. Jennings, Santa Clara City, CA (US)

Correspondence Address: BAKER BOTTS L.L.P., 2001 ROSS AVENUE, SUITE 600, DALLAS, TX, 75201-2980, US

(73) Assignee: Cisco Technology, Inc.

(21) Appl. No.: 11/112,211

(22) Filed: Apr. 22, 2005

(51) Int. Cl. H04Q 11/00

(52) U.S. Cl. 370/260

(57) ABSTRACT

A system for managing an ongoing conference provides a conference management system that enables contact with missing conference invitees during a conference. The system can identify one or more missing conference invitees, identify communication addresses for the missing conference invitees, and contact the missing conference invitees during a conference.

### TECHNICAL FIELD OF THE INVENTION

The present invention relates generally to conference management, and more particularly to management of an ongoing conference through the display of missing invitees and the use of ongoing conference notifications.

### BACKGROUND OF THE INVENTION

There are many methods available for groups of individuals to engage in conferencing. One common method, teleconferencing, involves one or more individuals located in one location engaging in a conference telephone call with one or more individuals located in at least one other location, remote from the first. Often teleconferencing involves the use of one or more speaker phones. Similarly, video conferencing, web conferencing, data conferencing, online meetings, and other technologies provide methods for multiple individuals to meet and communicate ideas and information from remote locations.

### SUMMARY OF THE INVENTION

In accordance with the present invention, techniques for managing an ongoing conference are provided. According to some embodiments, these techniques can enable a conference administrator to display information about missing conference attendees, including their network presence status, schedules, and contact information. These techniques may also allow the conference administrator to notify one or more missing conference invitees of the scheduled conference, while the conference is ongoing, through one or more communication devices associated with each missing conference invitee.

According to a particular embodiment, a system for managing an ongoing conference includes a database, a processing module, a graphical user interface, and a network interface. The database includes conference invitee information, invitee communication addresses, and invitee notification logic. The processing module is able to access the database, identify a plurality of conference invitees for a scheduled conference, and monitor a communication session established for the scheduled conference. The processing module is also able to identify one or more conference attendees participating in the communication session, identify one or more missing conference invitees, identify one or more communication addresses for the missing conference invitees, and receive a notification selection, indicating one or more selected ones of the communication addresses. The graphical user interface is able to present, for each of the missing conference invitees, contact options linked to the one or more communication addresses; and the network interface is operable to send an ongoing conference notification to the selected communication addresses.

Embodiments of the invention provide various technical advantages. For example, these techniques may allow a conference administrator to view a graphical display representing contact information and presence status for each missing conference invitee during a scheduled meeting. These techniques may also allow the conference administrator to send a notification to one or more of the missing conference invitees, notifying them of the ongoing meeting and providing them with information to assist them in joining the ongoing conference. This may serve as a reminder to conference invitees who may have forgotten about the conference. Additionally, these techniques may allow a conference administrator to contact multiple missing conference invitees simultaneously using one or more communication addresses for each missing conference invitee, while the conference is ongoing. These techniques may also allow a conference invitee to connect to the ongoing conference in response to a notification. This may allow the conference invitee to connect to the conference using one or more of multiple communication devices, which may circumvent certain technical problems which prevented the conference invitee from initially being included in the conference. Furthermore, by sending out an ongoing conference notification, certain conference attendees, who were previously unable to agree to the conference time, may connect to the ongoing conference in response to receiving the notification, as a result of a change or opening in their schedules.

Other technical advantages of the present invention will be readily apparent to one skilled in the art from the following figures, descriptions, and claims. Moreover, while specific advantages have been enumerated above, various embodiments may include all, some, or none of the enumerated advantages.

### BRIEF DESCRIPTION OF THE DRAWINGS

For a more complete understanding of the present invention and its advantages, reference is now made to the following description, taken in conjunction with the accompanying drawings, in which:

FIG. 1 illustrates a system having elements to support the management of an ongoing conference;

FIG. 2 illustrates example communication devices associated with conference attendees and missing conference invitees;

FIG. 3 is a block diagram illustrating functional components of a conference management module associated with the conference management system;

FIG. 4 illustrates a graphical user interface for managing an ongoing conference; and

FIG. 5 is a flowchart illustrating a method for managing an ongoing conference.

### DETAILED DESCRIPTION OF THE DRAWINGS

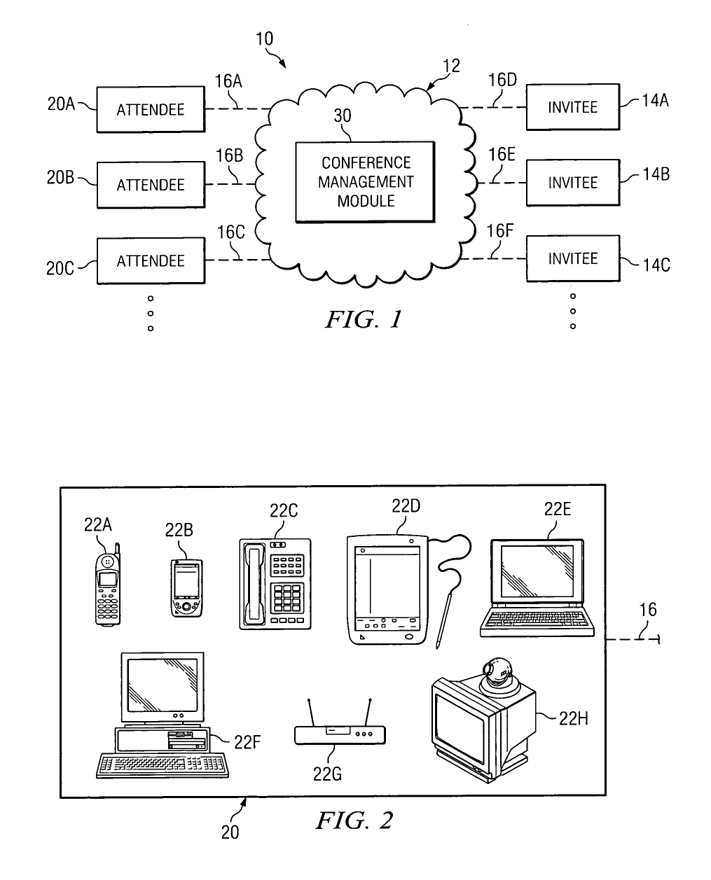

FIG. 1 illustrates a conference management system, indicated generally at 10, that includes network 12, conference attendees 20, missing conference invitees 14, network connections 16, and conference management module 30. The elements of conference management system 10 can operate to enable a conference administrator to manage an ongoing conference.

Network 12 represents communication equipment, including hardware and any appropriate controlling logic, for interconnecting elements coupled to network 12. Thus network 12 may represent a local area network (LAN), a metropolitan area network (MAN), a wide area network (WAN), and/or any other appropriate form of network. Furthermore, elements within network 12 may utilize circuit-switched and/or packet-based communication protocols to provide for network communications. The elements within network 12 may be connected together via a plurality of fiber-optic cables, coaxial cables, twisted-pair lines, and/or other physical media for transferring communications signals. The elements within network 12 may also be connected together through wireless transmissions, including infrared transmissions, 802.11 protocol transmissions, laser line-of-sight transmissions, or any other wireless transmission method.

Conference attendee 20 represents one or more individuals or groups of individuals who are present for a scheduled conference. The presence of conference attendee 20 may consist of being connected to a teleconference via a deskphone, a cellular phone, a speaker phone located in a conference room, or any other voice communication device capable of connecting conference attendee 20 to a teleconference. The presence of conference attendee 20 may also consist of being connected to a web conference via a laptop, desktop computer, television set-top box, tablet computer, personal digital assistant, or any other communication device capable of connecting conference attendee 20 to a web conference. Multiple conference attendees 20 may be co-located during the conference, or each conference attendee 20 may be located in a separate location. In addition, conference attendee 20 may be in a stationary location during the conference, or conference attendee 20 may be using a mobile communication device 22 and their location may change during the conference. Furthermore, conference attendee 20 may connect to the scheduled conference using more than one communication device during the conference. For example, conference attendee 20 may begin the conference using a cellular phone to connect to the conference and then transition to a desktop telephone or a desktop computer while the conference is still ongoing. While it is not necessary, one of the conference attendees 20 may also be the conference administrator for the scheduled conference.

Missing conference invitee 14 represents one or more individuals or groups of individuals who have been invited to a scheduled conference, but who are not present during the scheduled conference. Associated with each missing conference invitee 14 or group of missing conference invitees 14 are one or more communication devices.

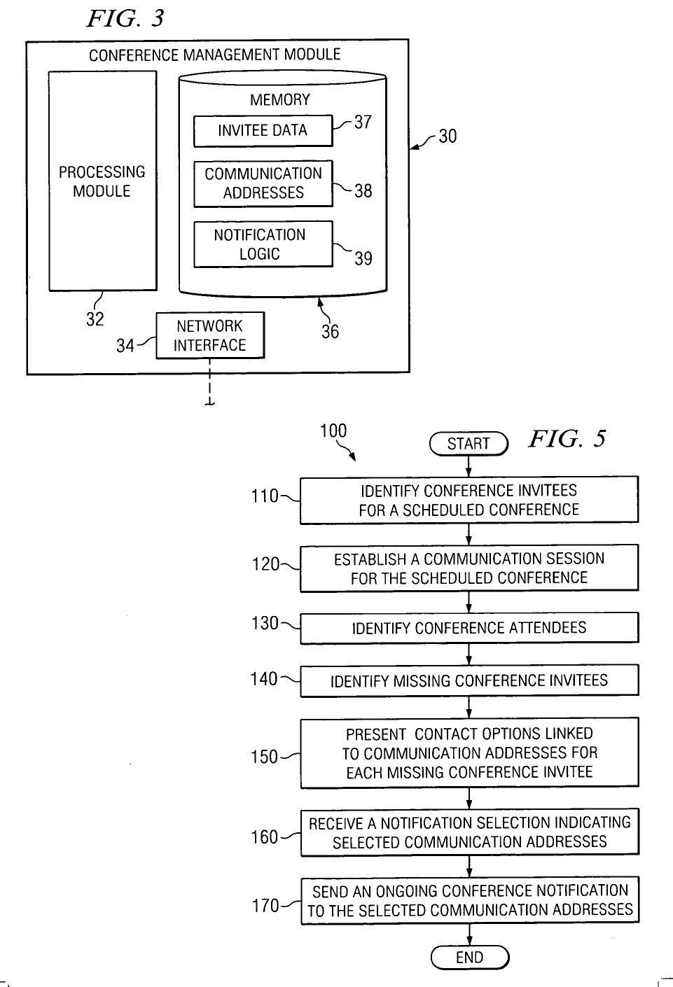

Conference management module 30 represents hardware and controlling logic for managing an ongoing conference. Conference management module 30 may operate to schedule a conference and establish a communication session for the scheduled conference. Conference management module 30 may also operate to identify conference attendees 20 and missing conference invitees 14, and may operate to send ongoing conference notifications to missing conference invitees 14. Further description of conference management module 30 is included below in relation to FIG. 3.

Network connection 16, represents hardware for connecting network 12 to other elements of conference management system 10. Network connection 16 may include fiber optic cable, twisted pair cable, coaxial cable, or any physical media adapted to allow the transmission of communication signals between network 12 and the other elements of conference management system 10. Network connection 16 may also represent one or more wireless connections using technologies such as infrared transmissions, 802.11 protocol transmissions, laser line-of-sight transmission, etc. Additionally, network connection 16 may include one or more external networks, such as the public switched telephone network (PSTN), private networks and/or the Internet. Although not explicitly shown in FIG. 1, elements of conference management system 10 may couple directly to network 12, without the use of network connections 16.

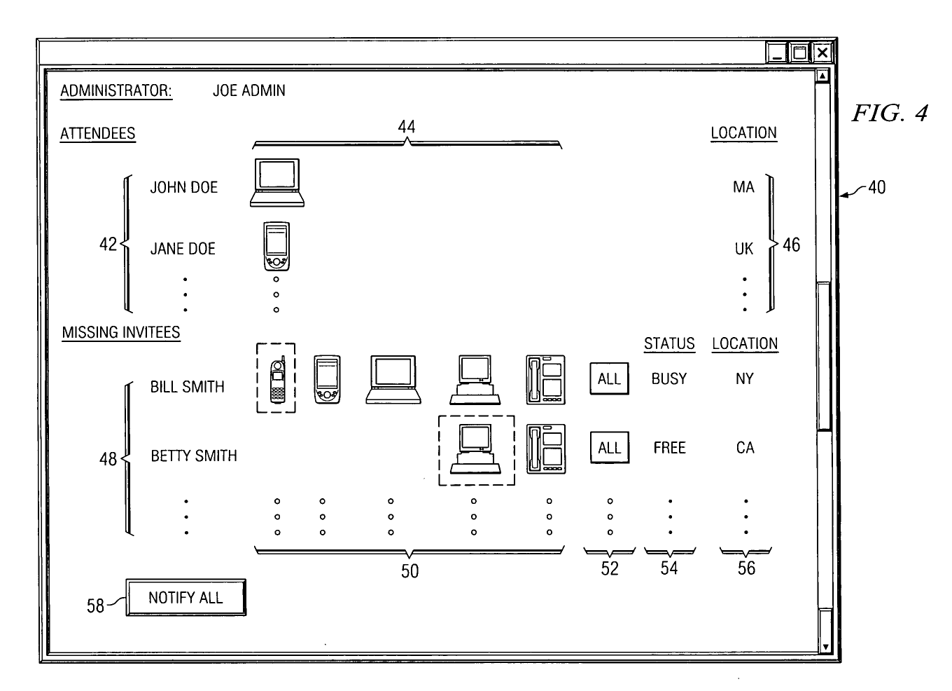

In operation, conference management module 30 maintains information regarding invitees for a scheduled conference. This information may include communication addresses, presence information, schedules, etc. When the time for the scheduled conference occurs, one or more conference invitees connect to establish a communication session for the scheduled conference. The communication session may be a teleconference, a video conference, a web conference, a data conference, or any other conferencing technology which provides for remote communications between a plurality of individuals or groups of individuals. Once the communication session has been established, conference management module 30 identifies conference attendees 20 and missing conference invitees 14. Conference management module 30 may then present a graphical user interface which includes information regarding conference attendees 20 and missing conference invitees 14. An illustration of one embodiment of the graphical user interface is shown in FIG. 4, and further description of the graphical user interface is included below in relation to FIG. 4.

A conference administrator can use the graphical user interface to select one or more missing conference invitees 14. For each selected missing conference invitee 14, the conference administrator can select one or more communication devices through which to contact missing conference invitee 14. Conference management module 30 may then generate one or more ongoing conference notifications and send the one or more ongoing conference notifications to the selected communication devices for the selected missing conference attendees 14. The ongoing conference notifications may be customized for each type of communication device and/or customized for each missing conference invitee 14. For example, the ongoing conference notification may be a recorded or simulated voice message reminding missing conference invitee 14 of the ongoing scheduled conference. The ongoing conference notification may also be an e-mail message, an instant message, an application driven pop-up window, or any other notification technology capable of communicating the existence and ongoing nature of the scheduled conference, in substantially real-time.

In one embodiment, the ongoing call notification would provide a method for missing conference invitee 14, upon receiving the ongoing call notification, to join the ongoing conference. As one example, if the ongoing call notification were received on a cellular phone, the ongoing call notification might provide a number that missing conference invitee 14 could call to join the ongoing conference. As another example, the ongoing call notification may be in the form of a call that, if answered, can be linked to the conference. In this embodiment, the ongoing call notification may be in the form of an interactive voice response system that can link conference invitee to the ongoing conference upon receiving a specified response. As yet another example, if the ongoing call notification were an e-mail, the email message might contain a link to the ongoing conference.

FIG. 2 illustrates communication devices 22 that may be associated with a system user, such as conference attendee 20 or missing conference invitee 14. Communication devices 22 represent one or more of a plurality of hardware devices capable of transmitting electronic communication signals through network 12. Communication devices 22 may represent portable or fixed location devices capable of transmitting communication signals through one or more appropriate wireless or wireline protocols. For example, communication devices 22 may include cellular phones 22A, personal digital assistants 22B, desktop phones 22C, tablet computers 22D, laptop computers 22E, desktop computers 22F, video conferencing systems 22G, television set-top boxes 22H, etc. Additionally, communication devices 22 may connect using one or more mobile communication technologies, such as global systems for mobile communications (GSM) and/or code division multiple access (CDMA). Furthermore, communication devices 22 may support packet based protocols such as Internet protocol (IP) and wireless standards such as the 802.11 family of wireless standards. In certain embodiments, attendee 20 may be associated with numerous communication devices 22, all of which transmit communication signals through network 12. Similarly, missing conference invitee 14 may be associated with numerous communication devices 22, all of which transmit communication signals through network 12.

In operation, conference attendee 20 and missing conference invitee 14 connect to network 12 through one or more communication devices 22. Conference attendee 20 may join a conference using one or more communication devices 22. Similarly, missing conference invitee 14 may receive an ongoing conference notification through one or more communication devices 22.

FIG. 3 is a block diagram illustrating functional components of conference management module 30. In the embodiment illustrated, conference management module 30 includes processor module 32, network interface 34, and memory 36. These components operate to enable conference management module 30 to manage an ongoing conference and to notify missing conference invitees 14 of the ongoing conference.

Processor module 32 controls the operation and administration of elements within conference management module 30 by processing information received from network interface 34 and memory 36. Processor module 32 includes any hardware and/or controlling logic elements operable to control and process information. For example, processor 32 may be a programmable logic device, a microcontroller, and/or any other suitable processing device or group of devices.

Network interface 34 communicates information to and receives information from devices coupled to conference management module 30. For example, network interface 34 may communicate with communication devices 22, network 12, and elements coupled to network 12. Thus network interface 34 includes any suitable hardware and/or controlling logic used to communicate information to and from elements coupled to conference management module 30.

Memory 36 stores, either permanently or temporarily, data and other information for processing by processor module 32 and communication using network interface 34. Memory 36 includes any one or a combination of volatile or nonvolatile local or remote devices suitable for storing information. For example, memory 36 may include random access memory (RAM), read only memory (ROM), magnetic storage devices, optical storage devices, or any other suitable information storage device or combination of these devices.

Memory 36 may store, among other things, conference invitee data 37, invitee communication addresses 38, and invitee notification logic 39. Conference invitee data 37 includes information related to conference invitees, such as names, preferences, primary locations, etc. Invitee communication addresses 38 include the addresses for communication devices 22 associated with conference invitees. Invitee communication addresses 22 may include phone numbers, e-mail addresses, network identifiers, port addresses, or any other information necessary to transmit an ongoing conference notification to each of the communication devices 22 associated with a conference invitee. Invitee communication addresses 22 may be used by conference management module 30 to establish the communication session for the scheduled conference and/or to send ongoing conference notifications to missing conference invitees 14.

Invitee notification logic 39 includes code, executable files, and/or appropriate software modules capable, when executed, of controlling the operation of conference management module 30 as it relates to generating and sending ongoing conference notifications. Invitee notification logic includes logic necessary to identify missing conference invitees, present contact options linked to the one or more communication addresses for each missing conference invitee 14, generate ongoing conference notifications and send the ongoing conference notifications to selected communication addresses.

In operation conference management module 30 receives a selection from a conference administrator and applies invitee notification logic 39 to create ongoing conference notifications and send these ongoing conference notifications to each selected communication address.

FIG. 4 illustrates graphical user interface 40. Graphical user interface 40 represents one possible method for conference management module 30 to present contact options and to receive a notification selection. As shown, graphical user interface 40 includes attendee list 42, attendee device indicators 44, and attendee location indicators 46. In addition, graphical user interface 40 includes missing invitee list 48, invitee device indicators 50, invitee ‘select all’ buttons 52, invitee status indicators 54, invitee location indicators 56, and notification action button 58.

In operation, a conference administrator may use graphical user interface 40 to control the operation of conference management module 30, with respect to the notification of missing conference invitees 14 regarding an ongoing conference. The appearance and content of graphical user interface 40 may be controlled by conference management module 30.

Attendee list 42 represents the one or more conference attendees 20, present at the ongoing conference. Attendee list 42 may include a list of names, titles, and/or associated entities. Attendee list 42 may also include icons and/or other graphical or textual displays indicating the conference attendees 20 present at the ongoing conference. Adjacent to attendee list 42 are attendee device indicators 44. As shown, attendee device indicators 44 include icons representing the type of communication device 22 each conference attendee 20 is using to attend the ongoing conference. In the example shown, conference attendees 20 are attending the ongoing conference through the use of a laptop computer and a personal digital assistant. In other embodiments, attendee device indicator 44 may include other forms of graphical or textual indicators that may represent the type of communication device 22 each conference attendee 20 is using to attend the ongoing conference. In addition, graphical user interface 40 may include attendee location indicators 46. Attendee location indicators 46 represent icons and/or other graphical or textual representations indicating the current location of each individual or group of conference attendees 20. The precision of attendee location indicators 46 may vary from one embodiment to another. For example, in one embodiment, attendee location indicator 46 may indicate the conference room where conference attendee 20 is located. While in other embodiments, attendee location indicator 46 may indicate which city, state, country, and/or international time zone where attendee 20 is located. Attendee location indicator 46 may also indicate the local time where conference attendee 20 is located.

In operation, graphical user display 40 will provide information to the conference administrator regarding conference attendees 20 through the use of attendee list 42, attendee device indicators 42, and attendee location indicators 46. These elements of graphical user display 40 may provide real-time or near-real-time information regarding all conference attendees 20.

Missing invitee list 48 represents the one or more missing conference invitees 14 not present at the ongoing conference. As with attendee list 42, missing invitee list 48 may include a list of names, titles, and/or associated entities. Missing invitee list 48 may also include icons and/or other graphical or textual displays indicating the missing conference invitees 14 not present at the ongoing conference. Adjacent to missing invitee list 48 are invitee device indicators 50. Invitee device indicators 50 represent indicators of the different communication devices 22 associated with each missing conference invitee 14. As shown, one or more invitee device indicators 50 may be highlighted and/or set apart to indicate an online presence status and/or a preference indication for those communication devices 22.

In one embodiment, the conference administrator may select one or more communication devices 22 by selecting the appropriate invitee device indicator 50. Conference management module 30 will then generate and send ongoing conference notifications to those communication devices 22 associated with the selected invitee device indicators 50. In addition, in the embodiment shown, graphical user interface 40 includes invitee ‘select-all’ buttons 52, which may be used by the conference administrator to select all of the communication devices 22 associated with the selected missing conference invitees 14. By activating invitee ‘select-all’ button 52, the conference administrator may communicate, to the conference management module, a selection of all of the communication devices 22 associated with a certain missing conference invitee 14. The conference management module 30 may then generate and send ongoing conference notifications to each of those selected communication devices 22.

Invitee status indicator 54 represents additional status information regarding missing conference invitee 14. For example, invitee status indicator 54 may indicate the network presence of missing conference invitee 14. In this embodiment conference management module 30 may access information from one or more applications or databases to determine whether missing conference invitee 14 is present or not present with respect to network 12. Invitee status indicator 54 may also indicate a scheduling status of missing conference invitee 14. In this embodiment, conference management module 30 may access information from one or more scheduling applications or databases, such as OUTLOOK, to determine whether missing conference invitee 14 is free, busy, out-of-the-office, etc.

Similar to attendee location indicators 46, invitee location indicators 56 represent icons and/or other graphical or textual representations indicating the current location of each individual or group of missing conference invitees. Invitee location indicator 56 may display information indicating the conference room, city, state, country, and/or international time zone where missing conference invitee 14 is located. In one embodiment, invitee location indicator 56 indicates the local time where missing conference invitee 14 is located.

Notification action button 58, as shown, represents a simplified method for the conference administrator to communicate the selection of all missing conference invitees 14 to conference management module 30. In one embodiment, activation of notification action button 58 may result in the selection of each communication device 22 associated with each missing conference invitee 14. In another embodiment, activation of notification action button 58 may result in the selection of a preferred communication device 22 associated with each missing conference attendee. The preferred communication device may be determined based on information provided by the conference administrator, upon preferences established by the missing conference invitees 14, upon the most recent device used by a missing conference invitee 14, upon network presence information for the communication devices 22, or other appropriate criteria.

FIG. 5 is a flowchart illustrating a method, indicated generally at 100, for managing an ongoing conference. Conference management module 30 identifies conference invitees for a scheduled conference at step 110, and then establishes a communication session for the scheduled conference at step 120. At step 130, conference management module 30 identifies conference attendees 20 and, at step 140, identifies missing conference invitees 14. Then, at step 150, conference management module 30 presents contact options linked to communication addresses for each missing conference invitee 14. At step 160, conference management module 30 receives a notification selection indicating selected communication addresses. In response to the selection, at step 170, conference management module 30 sends an ongoing conference notification to the selected communication addresses.

Thus, method 100 represents a series of steps for managing an ongoing conference. Method 100 represents an example of one mode of operation, and conference management system 10 contemplates devices using suitable techniques, elements, and applications for performing this mode of operation. Many of the steps in the flowchart may take place simultaneously and/or in a different order than shown. In addition, the devices may use any methods with additional or fewer steps to manage an ongoing conference call.

Although the present invention has been described in several embodiments, a myriad of changes and modifications may be suggested to one skilled in the art, and it is intended that the present invention encompass such changes and modifications as fall within the present appended claims.

What is claimed is:

1. A system for managing a conference comprising:
a database maintaining a plurality of conference profiles, each scheduled conference profile identifying schedule information, a plurality of conference invitees and, for each of the conference invitees, at least one communication address;
a processing module operable to:
select one of the conference profiles;
identify the conference invitees for a selected conference profile;
monitor a communication session established for the selected conference profile;
identify one or more missing ones of the conference invitees not participating in the communication session;
determine, for each of the missing conference invitees, the communication address indicated in the conference profile;
present, for each of the missing conference invitees, at least one contact option linked to the communication address; and
receive a notification selection indicating one or more selected ones of the identified communication addresses; and
a network interface operable to send an ongoing conference notification to the selected communication addresses.

2. The system of claim 1, wherein the controller is further operable to present a graphical user interface displaying, for each of the missing conference invitees, the contact options linked to the one or more identified communication addresses.

3. The system of claim 2, wherein displaying comprises visually presenting a plurality of icons each linked to a selected one of the contact options.

4. The system of claim 1, wherein the processing module is further operable to determine a presence status for each of the missing conference invitees, wherein each presence status indicates an availability of a network device associated with the communication address for the missing conference invitee, and present the presence status for each of the missing conference invitees.

5. The system of claim 1, wherein the processing module is further operable, for each of the missing conference attendees, to access scheduling software for the missing conference invitee, to determine schedule information indicating scheduled activities for the conference invitee, and to present the schedule information.

6. The system of claim 5, wherein the schedule information comprises calendar entries from a commercially available software application.

7. The system of claim 1, wherein:
the processing module is further operable to present an option to contact all of the missing conference invitees and to receive a selection of the option to contact all of the missing conference invitees; and
the network interface is further operable to send an ongoing conference notification to at least one of the communication addresses for each of the missing conference invitees.

8. A method for managing an ongoing conference comprising:
identifying a plurality of conference invitees for a scheduled conference;
monitoring a communication session established for the scheduled conference;
identifying one or more missing ones of the conference invitees not participating in the communication session;
determining, for each of the missing conference invitees, one or more associated communication addresses;
presenting, for each of the missing conference invitees, at least one contact option linked to the communication addresses;
receiving a notification selection indicating one or more selected ones of the contact options; and
sending an ongoing conference notification to the communication addresses linked to the selected contact options.

9. The method of claim 8, further comprising presenting a graphical user interface displaying, for each of the missing conference invitees, the contact options linked to the one or more identified communication addresses.

10. The method of claim 8, wherein presenting comprises visually displaying icons representing each of the contact options.

11. The method of claim 8, further comprising determining a presence status for each of the missing conference invitees, wherein each presence status indicates an availability of a network device associated with the communication address for the missing conference invitee, and presenting the presence status for each of the missing conference invitees.

12. The method of claim 8, further comprising, for each of the missing conference attendees, accessing scheduling software for the missing conference invitee, determining schedule information indicating scheduled activities for the conference invitee, and presenting the schedule information.

13. The method of claim 12, wherein the schedule information comprises calendar entries from a commercially available software application.

14. The method of claim 8, further comprising;
presenting an option to contact all of the missing conference invitees;
receiving a selection of the option to contact all of the missing conference invitees; and
sending an ongoing conference notification to at least one of the communication addresses for each of the missing conference invitees.

15. Software for managing an ongoing conference, the software embodied in computer-readable media and when executed operable to:
identify a plurality of conference invitees for a scheduled conference;
monitor a communication session established for the scheduled conference;
identify one or more missing ones of the conference invitees not participating in the communication session;
determine, for each of the missing conference invitees, one or more associated communication addresses;
present, for each of the missing conference invitees, at least one contact option linked to the communication addresses;
receive a notification selection indicating one or more selected ones of the contact options; and
send an ongoing conference notification to the communication addresses linked to the selected contact options.

16. The software of claim 15, further operable when executed to present a graphical user interface displaying, for each of the missing conference invitees, the contact options linked to the one or more identified communication addresses.

17. The software of claim 15, wherein presenting comprises visually displaying icons representing each of the contact options.

18. The software of claim 15, further operable when executed to determine a presence status for each of the missing conference invitees, wherein each presence status indicates an availability of a network device associated with the communication address for the missing conference invitee, and to present the presence status for each of the missing conference invitees.

19. The software of claim 15, further operable when executed, for each of the missing conference attendees, to access scheduling software for the missing conference invitee, to determine schedule information indicating scheduled activities for the conference invitee, and to present the schedule information.

20. The software of claim 19, wherein the schedule information comprises calendar entries from a commercially available software application.

21. The software of claim 15, further operable when executed to:
present an option to contact all of the missing conference invitees;
receive a selection of the option to contact all of the missing conference invitees; and
send an ongoing conference notification to at least one of the communication addresses for each of the missing conference invitees.

22. A system for managing an ongoing conference comprising:
means for identifying a plurality of conference invitees for a scheduled conference;
means for monitoring a communication session established for the scheduled conference;
means for identifying one or more missing ones of the conference invitees not participating in the communication session;
means for determining, for each of the missing conference invitees, one or more associated communication addresses;
means for presenting, for each of the missing conference invitees, at least one contact option linked to the communication addresses;
means for receiving a notification selection indicating one or more selected ones of the contact options; and
means for sending an ongoing conference notification to the communication addresses linked to the selected contact options.
